(19) United States
(12) Patent Application Publication
(10) Pub. No.: US 2014/0178603 A1
(43) Pub. Date: Jun. 26, 2014

(54) ADHESIVE TAPE MAKING METHOD AND EQUIPMENT USED IN THE SAME

(71) Applicant: HON HAI PRECISION INDUSTRY CO., LTD., New Taipei (TW)

(72) Inventor: PEI-RONG SHIEH, New Taipei (TW)

(73) Assignee: HON HAI PRECISION INDUSTRY CO., LTD., New Taipei (TW)

(21) Appl. No.: 14/108,527

(22) Filed: Dec. 17, 2013

(30) Foreign Application Priority Data
Dec. 24, 2012 (TW) 101149438

(51) Int. Cl. C09J 7/02

(52) U.S. Cl. CPC C09J 7/02
USPC 427/557; 427/207.1; 118/206; 118/642

(57) ABSTRACT

An adhesive tape making equipment, includes a coating roll, a spraying member, and a plurality of transporting rolls. A first adhesive is coated on the coating roll. A second adhesive is placed in the spraying member. An adhesive force of the first adhesive is higher than an adhesive force of the second adhesive. The coating roll and the spraying member are located between the plurality of transporting rolls. A method of making the adhesive tape is further provided.

### BACKGROUND

1. Technical Field

The present disclosure relates to methods of making an adhesive tape, and particularly to a method of making an adhesive tape that can be easily peeled off and equipment used in the method.

2. Description of the Related Art

In an assembling process of consumer electronics, an adhesive tape is used to bond two workpieces together. The adhesive tape should have a good adhesive force to bond the workpieces together strongly. The adhesive tape should also be easily peeled off from the two workpieces during reworking processes. Know methods of making the adhesive tape include rotate pressing a protective layer by a coating roll to form an adhesive layer; and drying the protective layer and the adhesive layer to obtain the adhesive tape. However, the adhesive tapes obtained by the known methods may not have a good adhesive force and a good peeling ability.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 shows an isometric view of an embodiment of an adhesive tape.

FIG. 2 shows a diagram of one embodiment of equipment.

FIG. 3 shows a diagram of a spraying member of the equipment in FIG. 2.

FIG. 4 shows a flow chart of a method of making the embodiment of the adhesive tape shown in FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

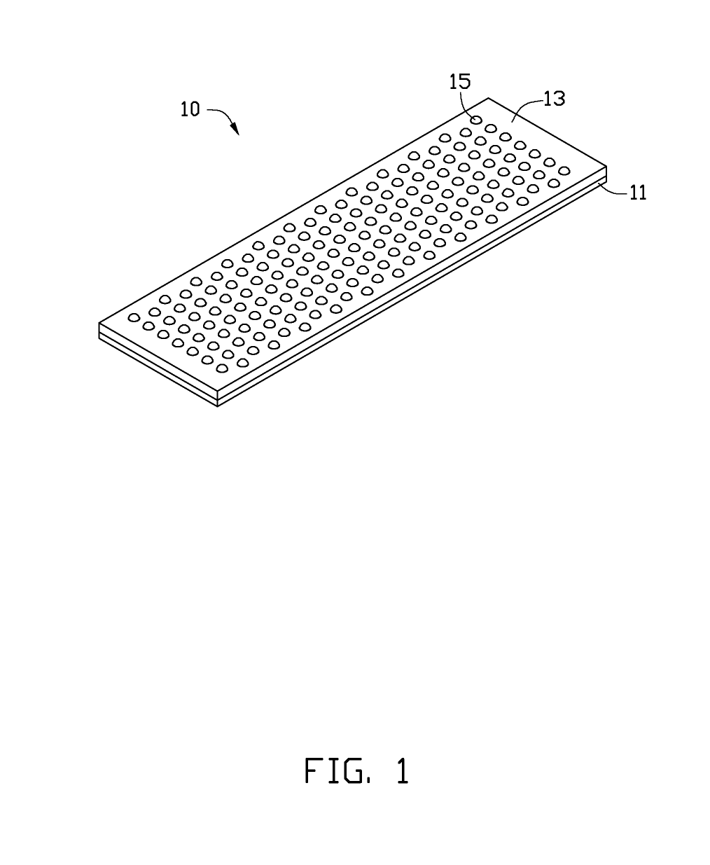

FIG. 1 shows one embodiment of an adhesive tape 10. The adhesive tape 10 includes a substrate 11, an adhesive layer 13 formed on the substrate 11, and a plurality of adhesive particles 15 dispersed on the adhesive layer 13. The substrate 11 is made of release paper, such as plastic film, and kraft paper. An adhesive force of the adhesive layer 13 is higher than an adhesive force of the adhesive particles 15. In an illustrated embodiment, the adhesive force of the adhesive layer 13 is equal to or higher than about 10 Newton per inch (N/in). The adhesive force of the adhesive particles 15 is in a range from about 1 N/in to about 10 N/in.

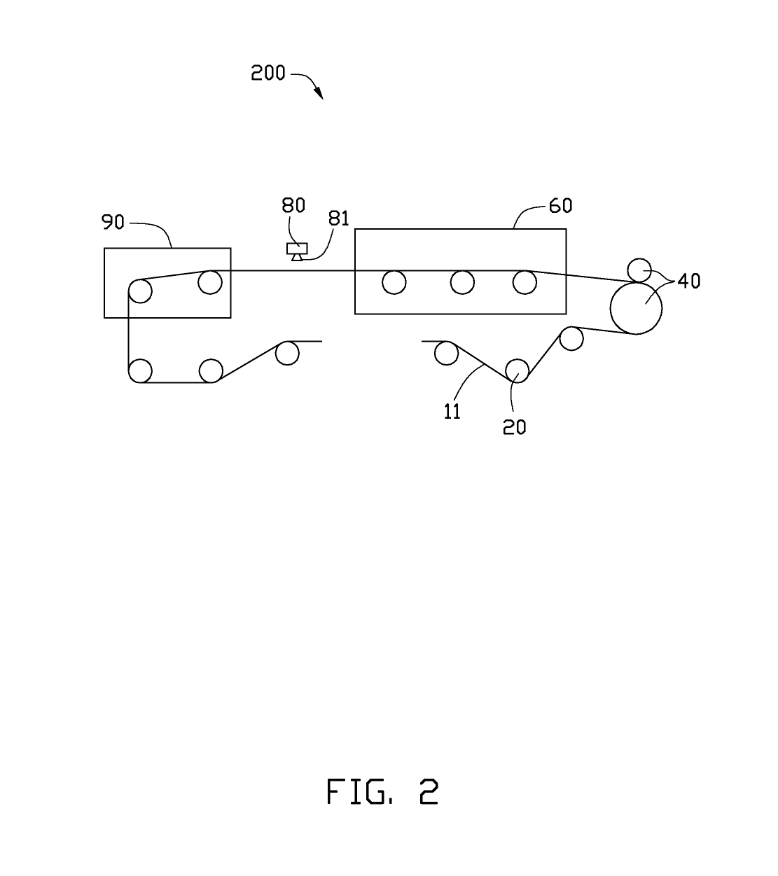

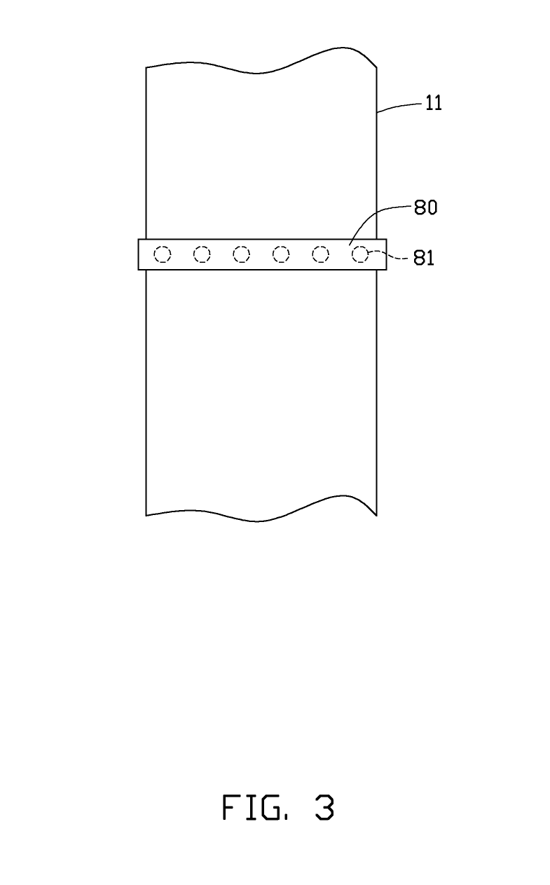

FIGS. 2 through 3 show equipment 200 for making the adhesive tape 10. The equipment 200 includes a plurality of transporting rolls 20, a coating roll 40, a first drying member 60, a spraying member 80, and a second drying member 90. The transporting rolls 20 are placed along a transporting route of the substrate 11 and spaced from each other. The coating roll 40, the first drying member 60, the spraying member 80, and the second drying member 90 are located between the transporting rolls 20. The coating roll 40 and the spraying member 80 are respectively located adjacent opposite ends of the first drying member 60. The first drying member 60 and the second drying member 90 are respectively located adjacent opposite sides of the spraying member 80.

The transporting rolls 20 are configured for supporting and transporting the substrate 11 in the method of making the adhesive tape 100. A first adhesive is coated on the coating roll 20, and the coating roll 20 is used for coating the first adhesive on the substrate 11 to form the adhesive layer 13. When forming the adhesive layer 13 on the substrate 11, solvent may remain in the adhesive layer 13, such that the first drying member 60 is configured for removing the solvent. The first drying member 60 can include a resistive heater or an infrared dryer. A second adhesive is placed in the spraying member 80, and the spraying member 80 is configured for spaying the second adhesive on the adhesive layer 13 to form a plurality of adhesive particles 15 spaced from each other. The spraying member 80 includes a plurality of spraying heads 81. The spraying heads 81 are located side by side across the width of the substrate 11. When spraying, the adhesive layer 13 formed on the protective layer 13 passes through the spraying heads 81, such that the adhesive particles 15 are formed on the adhesive layer 13 spaced from each other. The second drying member 90 is similar to the first drying member 60 and is configured for removing solvent in the adhesive particles 15. The second drying member 90 is located adjacent to the spraying member 80. The second drying member 90 and the first drying member 60 are located adjacent opposite sides of the spraying member 80.

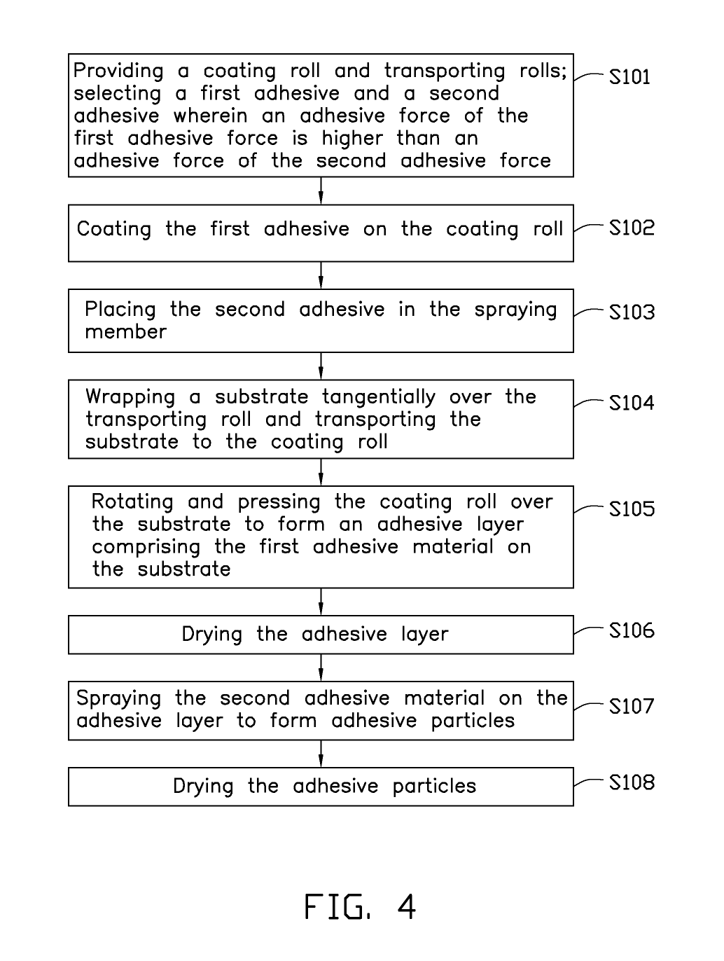

FIG. 4 shows one embodiment of the method of making the adhesive tape 10 as follows.

In step S101, the coating roll 40 and the spraying member 80 are placed between the transporting rolls 20.

In step S102, the coating roll 40 is coated with the first adhesive.

In step S103, the second adhesive is placed in the spraying member 80.

In step S104, the substrate 11 is tangentially wrapped over each of the transporting rolls 20 and transported to the coating roll 40 by rotating the transporting rolls 20. When the transporting rolls 20 are rotated, the substrate 11 is moved on a friction force between the substrate 11 and the transporting rolls 20.

In step S105, the coating roll 40 rotates and presses the substrate 11, such that the first adhesive is coated on a surface of the substrate 11 to form the adhesive layer 13.

In step S106, the substrate 11 that has been pressed is dried by the first drying member 60 to remove solvent in the adhesive layer 13.

In step S107, the substrate 11 is transported to pass by below the spraying member 80, such that the plurality of adhesive particles 15 is formed on the adhesive layer 12.

In step S108, the substrate 11 is dried by the second drying member 90 to remove solvent in the adhesive particles 15, thereby obtaining the adhesive tape 10.

After recycling the above-described steps S101 to S108 once, the above-described steps S104 to S108 can be performed at the same time, such that the adhesive tape 10 can be made continuously with a high efficiency.

In other embodiments, if there is no solvent remaining after forming the adhesive layer 13 and the adhesive particles 15, the first drying member 60 and the second drying member 90 can be omitted, and the steps S106 and S108 can be omitted. The first drying member 60 and the step S106 can be omitted, and solvent can be removed by the second drying member 90.

In the embodiment, the method of making the adhesive tape 10 is easy and simple, and the equipment 200 can be obtained by remanufacturing a present equipment for making a present adhesive tape, such that the cost is saved. In use, the adhesive particles 15 first contact with a workpiece (not shown), and the bonding strength between the adhesive tape 10 and the workpiece is relatively low, such that the adhesive tape 10 is easily peeled from the workpiece. Then, the adhesive tape 10 is pressed or/and heated, and then the adhesive layer 13 penetrates on the workpiece via gaps between the adhesive particles 15 after a predetermined time span and are adhered to the workpiece 200, such that the adhesive tape 10 is totally adhered to the workpiece 200, and the bonding strength between the adhesive tape 10 and the workpiece 200 is improved.

Depending on the embodiment, certain of the steps described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

It is to be understood, however, that even though numerous characteristics and advantages of the disclosure have been set forth in the foregoing description, together with details of the structure and function of the embodiments, the disclosure is illustrative only, and changes may be made in detail, especially in the matters of shape, size, and arrangement of parts within the principles of the embodiments to the full extent indicated by the broad general meaning of the terms in which the appended claims are expressed.

What is claimed is:

1. An adhesive tape making method, comprising steps as follows:
placing a coating roll and a spraying member between a plurality of transporting rolls;
coating a first adhesive on the coating roll;
placing a second adhesive in the spraying member, an adhesive force of the first adhesive being higher than an adhesive force of the second adhesive;
wrapping a substrate tangentially over each of the plurality of transporting rolls, and moving the substrate to the coating roll by rotating the plurality of transporting rolls;
rotating and pressing the coating roll over the substrate; and
spraying the second adhesive and forming adhesive particles on the substrate that has been pressed.

2. The adhesive tape making method of claim 1, the method comprises drying the substrate by a drying member after the step of rotating and pressing the coating roll over the substrate or the step of forming the adhesive particles on the substrate.

3. The adhesive tape making method of claim 2, wherein the substrate is dried by resistive heating or by infrared heating.

4. The adhesive tape making method of claim 1 further comprising placing a plurality of spraying heads side by side across a width of the substrate; and the second adhesive is sprayed on the substrate by the plurality of spraying heads.

5. An adhesive tape making equipment comprising:
a coating roll configured to be coated with a first adhesive;
a spraying member configured to contain a second adhesive; and
a plurality of transporting rolls, the coating roll and the spraying member being between the plurality of transporting rolls.

6. The adhesive tape making equipment of claim 5, wherein the equipment further comprises a first drying member, the coating roll and the spraying member are located adjacent opposite ends of the first drying member, respectively.

7. The adhesive tape making equipment of claim 6, wherein the first drying member comprises a resistive heater or an infrared dryer.

8. The adhesive tape making equipment claim 6, wherein the equipment further comprises a second drying member, the first drying member and the second drying member are located adjacent opposite sides of the spraying member, respectively.

9. The adhesive tape making equipment of claim 5, wherein the spraying member comprises a plurality of spraying heads arranged side by side.
